(19) United States
(12) Patent Application Publication
(10) Pub. No.: US 2019/0155048 A1
(43) Pub. Date: May 23, 2019

(54) METHOD FOR FITTING SPECTACLE LENSES INTO FULL RIM SPECTACLE FRAMES

(71) Applicant: Walter BERGNER, Bad Kreuznach (DE)

(72) Inventor: Walter BERGNER, Bad Kreuznach (DE)

(21) Appl. No.: 16/261,276

(22) Filed: Jan. 29, 2019

Related U.S. Application Data
(63) Continuation of application No. PCT/DE2017/100624, filed on Jul. 26, 2017.

(30) Foreign Application Priority Data
Jul. 29, 2016 (DE) 10 2016 114 125.9

(51) Int. Cl. G02C 1/00; G02C 13/00

(52) U.S. Cl. CPC G02C 1/10; G02C 13/001

(57) ABSTRACT

A method for fitting spectacle lenses into full rim spectacle frames, comprising machining the edge of the spectacle lenses to be fitted, wherein, a circumferential, step-like chamfer with a curvature determined as a section of a sphere surface with a defined radius is worked into the spectacle lens holders in the full rim spectacle frame on the front or back side, then the edge of the spectacle lenses is machined, in the form of a front-side or back-side circumferential step-like bevel with a curvature determined according to the sphere surface with a defined radius of the chamfer. The spectacle lenses are fitted into the holders in the full rim spectacle frames on the front or back side, with precise engagement of the bevel into the chamfer of the spectacle frame, and the inserted spectacle lenses are adhesively bonded and/or welded to the holders in the full rim spectacle frame.

One or more embodiments according to the present invention relates to a method for fitting spectacle lenses into full rim spectacle frames.

The prior art has disclosed many options for establishing a connection between a spectacle frame and spectacle lenses inserted into the spectacle frame. Here, a distinction is made between various forms of spectacle frames, such as full rim and half rim spectacle frames, and rimless spectacles, and also between the connection options in this respect, which, in turn, also require adaptation measures on the spectacle lenses to be inserted.

The laid-open application DE 10 2014 000 107 A1 has disclosed a spectacle lens which has at least one structure element on its outer edge or on its back surface, said structure element being applied to the spectacle lens as a liquid material. This structure element provides for fastening the spectacle lenses to the frame, for example by a plastic thread engaging in these structure elements.

The publication WO 99/40494 has disclosed a method and an apparatus for producing a bevel on the edge of a spectacle lens, which is implemented by way of a CNC-controlled machining machine. What is disclosed, within the scope of a plurality of steps, is first to capture the bevel groove of the spectacle lens and then to undertake the bevel machining with these established values. Accordingly, there is a disclosure of, in principle, exactly determining the spectacle bevel and working of said spectacle bevel in such a machining machine.

The publication U.S. Pat. No. 2,317,789 likewise has disclosed the design of the edge of a spectacle lens, which brings about a connection between the spectacle lens and a fastening element surrounding the spectacle lens, and consequently also between said spectacle lens and the temples and frame of a pair of spectacles.

The publication DE 10 2014 000 107 B4 describes a method for glazing a spectacle frame for the purposes of attaching a rimless spectacle lens, with a structure element also being fastened in this case.

Moreover, a spectacle lens with a deformable profile ring that is adhesively bonded to the edge or with a deformable profile ring that engages with an inlying undercut into a circumferential groove in the edge of the spectacle lens is described in U.S. Pat. No. 4,921,341.

A method and an apparatus for attaching a profiled strip to the contour-machined edge of a turning spectacle lens is described in DE 39 08 095 A1. Here, the profiled strip is placed around the entire circumference of the spectacle lens, following the spatial curve of the edge of the lens. To this end, the profiled strip start of an endless band is connected to the lens edge, a transverse perforation is made in the profiled strip at a distance of the circumference of the lens from the profiled strip start, the lens is rotated and the profiled strip portion behind the perforation in the movement direction of the profiled strip is stopped such that the perforation spot tears, whereupon the new strip start, formed thereby, for the next spectacle lens, which is not yet connected to the lens edge of the first spectacle lens, is now pressed against the edge of the next spectacle lens and connected to the latter. Here, the profiled strip is adhesively bonded, welded or lasered onto its target.

Patent DE 100 50 007 C2 describes a method for positioning a profiled strip on the edge of a spectacle lens, which sets the position of the profiled strip under CNC control, in accordance with a predetermined curve. Fastening to the spectacle lens then is implemented by activating or curing an adhesive between profile ring and spectacle lens.

The publication US 2005/0206834 A1 has disclosed a method in which a circumferential step-like chamfer is worked into the spectacle frame, the spectacle lenses to be inserted having a circumferential step-like bevel as a result of edge machining, said bevel representing a negative image of the chamfer worked into the spectacle frame, and the spectacle lenses are fitted into the holders of the spectacle frame with an exact engagement of the bevel in the chamfer.

The publication JP 2004-287277 discloses a cost-effective optical system, in which an optical element with an optical surface, which is symmetric in respect of only one plane of symmetry and fastened to an external component. Here, the optical element is inserted an a step in the connection region to the external component.

The publication WO 87/05123 A1 has disclosed a spectacle arrangement with a frame with an edge portion with an inner circumferential edge, which extends between the frame front side and the frame back side. Here, opposing areas of the edge portion define a groove in the circumferential border, the groove having a first ring-shaped back holding surface and an opposite ring-shaped front holding surface, both of which are substantially parallel to a plane extending between opposing areas of the inner edge border. An eyeglass lens element is dimensioned in such a way that it is received within the edge portion and said eyeglass lens element has an outer circumferential border dimensioned in such a way that it is received in the inner circumferential edge of the edge border. A back-side rib is arranged on the outer circumferential edge of the lens element, from where said rib protrudes into the groove.

The methods and apparatuses described in these publications are based on the basic concept of replacing the bevel that was previously ground into the main lens material in spectacle lens grinding machines with a circumferential profiled strand or profiled strip.

Although CNC-controlled spectacle lens edge grinding machines offer the option of adapting the bevel profile of a bevel to be ground to the profile of the bevel groove of a selected spectacle frame, the spectacle lens with the ground bevel is completely inelastic, and so stresses are transferred from the spectacle frame to the spectacle lenses during the insertion.

Stresses may also arise as a result of temperature change, with plastic lenses which tend to crack being sensitive thereto, in particular. An applied profiled strand could consist of an elastic material and thus facilitate a substantially better adaptation to the frame form. Furthermore, the manufacturing process would be simplified substantially and permit the use of alternative manufacturing methods, such as laser cutting, for example, since a two-dimensional manufacturing method suffices for producing an edge embodiment that is flat or only slightly curved in the direction of the optical axis.

Moreover, grinding a bevel means an additional work process which greatly lengthens the automated edge machining, in particular, on account of the required accuracy.

Despite the advantages over the prior art, the methods and concepts highlighted in the publications mentioned above have not been able to establish themselves commercially to date. This is due, inter alia, to one or more of the following points:
handling separate profiled strips and adhesives is difficult in practice and significantly increases the complexity of the machines,
it is not easy to adapt the geometry of the adhesively bonded or extruded profiled strands to different geometries of the frame groove,
spectacle lenses may have very thin edge regions locally; it is difficult to apply a profiled strand in these regions, with a protrusion of the profile beyond the edge of the spectacle lens being unacceptable,
the long-term durability and resilience of connections with adhesives as are used in profiled strips is critical, taking account of the ambient influences (sunlight, sweat from the skin).

Against this background, one or more objects of the present invention is to develop a method for fitting spectacle lenses, said method facilitating a fast and simple connection between spectacle lenses and full rim spectacle frames. Moreover, the novel method should in one or more embodiments facilitate an automated manufacture of spectacles by way of the automatization in relation to the connection between spectacle lenses and spectacle frame.

One or more of these objects is realized by a method in which the spectacle frame is produced or machined in such a way that a step-like chamfer, which serves as a holder for the spectacle lens, is worked into the opening, receiving the spectacle lens, on the front side or back side of the spectacle frame embodied as a full rim. In exchange, the spectacle lens element is machined on the edge in such a way that it exactly corresponds to the step-like chamfer in the spectacle frame in terms of form and size. That is to say, the spectacle lens element has a circumferential step-like bevel, which has a positive to negative relationship with the chamfer.

Here, provision is made for the chamfer worked into the spectacle frame to have a defined sphere radius r of greater than 50 mm. Naturally, the spectacle lens element employed here deviates therefrom on account of the employed lens thickness and the front and back surfaces, which may be spherical or spherical-cylindrical, with different curvatures. Nevertheless, the bevel adapted to the chamfer of the spectacle frame is fabricated to correspond exactly to the sphere radius used at the spectacle frame for fabricating the chamfer when machining the edge of the spectacle lens element, independently of these features such as lens thickness and surface curvature. Consequently, the spectacle lens is machined both in relation to the form profile of the spectacle frame and also in relation to the profile of the step-like chamfer on the spectacle frame.

The result of this procedure is an exact and joint-free connection between spectacle lens element and the spectacle frame. The secure connection between chamfer and bevel of the spectacle lens element should then be established by adhesive bonding or welding in accordance with one or more embodiments of the present disclosure.

Here, a substantial advantage is that, for the purposes of connecting the prepared components of spectacle frame and spectacle lens element, only a linear movement into the holder of the spectacle frame is required. This in turn simplifies the automation of the process for establishing a connection between spectacle lens element and spectacle frame since all that is required is this linear guidance of the spectacle lens into the exactly predetermined holder and chamfer of the spectacle frame.

In principle, different manufacturing methods on the part of the full rim spectacle frame are possible. On the one hand, when manufacturing the full rim spectacle frame from different materials, the production of such a chamfer, too, is already provided during manufacturing, for example from a plastic. The chamfer is embodied as a step that is arranged over the entire circumference on the inner side of the opening, holding the spectacle lens, of the spectacle frame and is arranged either on the front side or back side. Accordingly, in the case of a back-side insertion of the spectacle lens into such a spectacle frame, provision is made for a widened step to be worked into the frame on the back side.

Alternative options include milling this form of the step-like chamfer, even subsequently, into a plastic solid frame, for example. A further alternative lies in manufacturing such a solid frame as a three-dimensional workpiece in an additive manufacturing method, for example in 3-D printing as an additive manufacturing process. It is possible, here, to likewise directly use the construction values, which were adapted in a CAD process for the spectacle lens, for the production of the corresponding spectacle frame in 3-D printing and thus directly produce two components of the subsequent pair of spectacles that are exactly matched to one another.

Now, a correspondingly machined spectacle lens with a polished edge can be inserted with exact fit into the full rim spectacle frame that has thus been provided with a front-side, or else back-side, connection step or chamfer. To this end, the spectacle lens is machined on the edge in known technical fashion, either by a step-like bevel cut on the front side, which then facilitates an insertion, back-side, into the spectacle frame, or by a step-like bevel cut on the back side of the spectacle lens, which facilitates the insertion of the spectacle lens, front-side, in a corresponding step or chamfer worked into the spectacle frame.

The automation of the production of full rim spectacles by this improved connection method is simplified to the extent that the full rim spectacle frames with worked-in chamfer now only have to be brought, exactly aligned, into a manufacturing position by means of an appropriate conveying means, the spectacle lenses that have likewise been provided with a connection bevel being inserted into the holders in the full rim spectacle frame by means of a conveying element that receives or holds the spectacle lens in said manufacturing position. By embodying bevel and chamfer with an angled step cut, exact guidance of the spectacle lens into the provided holder in the spectacle frame is securely established.

Here, as an alternative, it is possible, firstly, to undertake fastening of the spectacle lens in the spectacle frame by way of a welded connection or, secondly, to provide an adhesive bond. In both cases, there is a combination of a positive connection with a welded or adhesively bonded connection, which reliably ensures a reliable hold of the spectacle lens in the spectacle frame. A combination of these connections is also possible.

In the case of a spectacle frame depth of approximately 4 mm, an idea of the connection according to an embodiment of the invention is obtained by way of the description of a hollow sphere with radius r=125 mm in the case of a wall thickness of approximately 4 mm. From a sphere portion of this hollow sphere, the spectacle frame, for example, is with the required features of the chamfer, worked into the back side or alternatively front side, with an abutment step, which may be cut out or formed by punching, for example. In the process, the spectacle lens to be inserted obtains a bevel which, firstly in a plan view of the spectacle lens, exactly follows the form of the spectacle frame and the chamfer worked therein and which, in a circumferential profile in a side view, follows the hollow sphere profile with r=125 mm, and so the spectacle frame chamfer and the spectacle lens bevel engage in one another seamlessly, as negative and positive, as soon as the spectacle lens is inserted into the spectacle frame. The sphere radius r chosen here in exemplary fashion is 125 mm. However, solutions from 50 mm to 150 mm are conceivable.

An exemplary design of an embodiment according to the invention is an interaction of a very thinly worked spectacle frame which tapers from a thickness of approximately 1.5 mm to approximately 1 mm thickness at its chamfer that is embodied in step-like fashion, i.e., which has a step of approximately 0.5 mm. This spectacle frame can be manufactured here from a relatively rigid metallic material, for example aluminum, or else from plastics and composite materials. The depth of this frame is approximately 4 mm in the exemplary design in order thus to allow the chamfer to be worked in and to achieve a sufficient connection area to the spectacle lens, which is of fundamental importance for the subsequent stability of the spectacles produced thus.

Here, it is a peculiarity of one or more embodiments according to the present invention that, prior to the connection to the spectacle lenses, the spectacle frame can be worked so finely that the latter still is unstable per se and has elastic properties. The spectacles overall having a stability and stiffness required for the demands of daily use, even if the spectacle frame per se has an extremely thin embodiment and thus is unstable per se, is only achieved by welding and/or adhesive bonding to the spectacle lens, which is fitted in interlocking fashion, and the bevel thereof.

Even though a full rim spectacle frame is used, this can make the latter appear as light and delicate in the finished pair of spectacles as in the case of a half rim pair of spectacles or a rimless pair of spectacles.

Since, however, the connection according to one or more embodiments of the invention of spectacle frame and spectacle lens moreover facilitates the aforementioned simplifications in respect of assembly and possible automation, this represents a significant improvement and expansion of the possibilities when designing spectacles.

Below, one or more embodiments of the invention is explained in more detail on the basis of drawings. In detail:

FIG. 1 shows a lateral view of a full rim spectacle frame according to the invention with a worked-in chamfer and lined-up spectacle lenses,

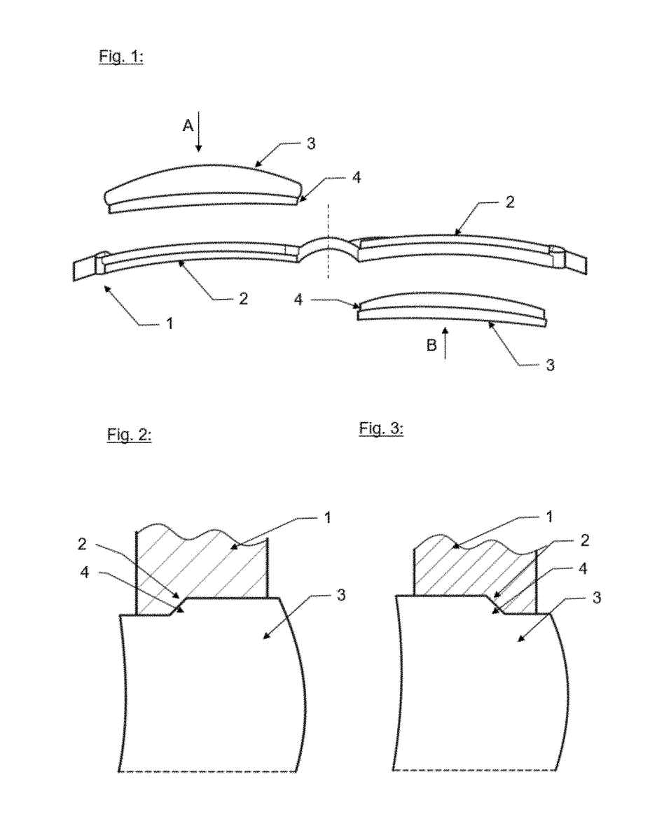

FIG. 2 shows a simplified sectional illustration of a spectacle lens inserted front-side into the spectacle frame,

FIG. 3 shows a simplified sectional illustration of a spectacle lens inserted back-side into the spectacle frame,

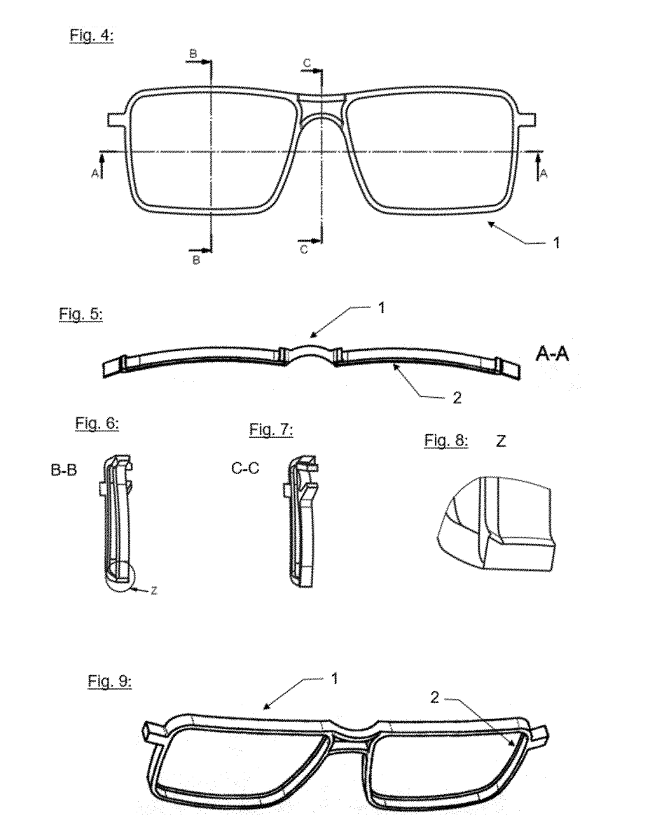

FIG. 4 shows a frontal view of a spectacle frame according to the invention in a simple embodiment,

FIG. 5 shows the section A-A through the spectacle frame according to the invention,

FIG. 6 shows the section B-B through the spectacle frame according to the invention,

FIG. 7 shows the section C-C through the spectacle frame according to the invention,

FIG. 8 shows a sectional magnification Z from FIG. 6,

FIG. 9 shows a perspective view of the spectacle frame according to the invention in a simple embodiment,

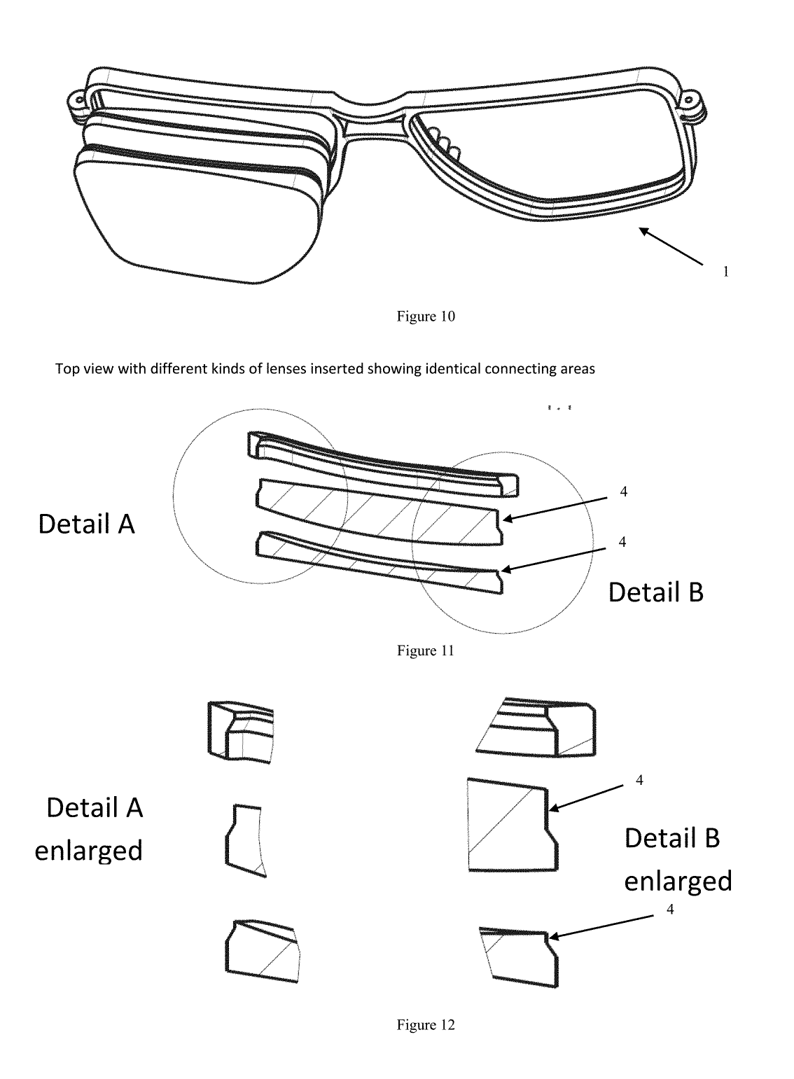

FIG. 10 shows an exploded perspective view of the spectacle frame according to the invention with lenses arranged for insertion,

FIG. 11 shows a detail view of two different lens types showing identical connecting areas, and

FIG. 12 shows a further detailed view of the lenses of FIG. 11.

FIG. 1 illustrates a lateral view of a full rim spectacle frame 1 according to an embodiment of the invention with a worked-in chamfer 2, wherein, for clarification purposes, a back-side insertion of the spectacle lens 3 is brought about by an appropriate arrangement of chamfer 2 and bevel 4 on the right-hand side and a front-side insertion of the spectacle lens 3 is provided on the left-hand side in this case.

The ground bevel 4 is likewise identifiable on the spectacle lens 3 itself, said bevel being embodied in the form of a step 5 that tapers to the front curvature of the spectacle lens 3 in the case of a back-side insertion into the spectacle frame 1 (arrow B). In the case of a front-side insertion of the spectacle lens 3 into the spectacle frame 1, the circumferential step 5 is ground into the back side of the spectacle lens 3 (arrow A). Accordingly, this figure only serves to clarify that provision can be made of both a front-side and a back-side insertion, with either the one or the other variant being able to be present on a spectacle frame.

FIGS. 2 and 3 show the inserted spectacle lenses 3 in the spectacle frames 1 in a simplified sectional illustration, wherein the spectacle lens is inserted front-side in FIG. 2 and back-side in FIG. 3. What was said previously in relation to the engaging arrangements of the step-like chamfer 2 and bevel 4 on the spectacle frame 1 and spectacle lens 2 also applies here. The thicknesses of spectacle lens and spectacle frame are not true to scale here.

FIG. 4 shows a frontal view of the spectacle frame 1 according to an embodiment of the invention in a simple embodiment. It is already clear from this that the spectacle frame can be worked to be very thin since the required stability is brought about by the subsequent connection to the spectacle lens. From the illustration, it is not possible to identify that even thinner, thread-like designs of the frame are realizable.

Here, a number of sections A-A, B-B and C-C are plotted in FIG. 4. These sections are found again in further FIGS. 5, 6 and 7.

The section A-A in this case shows a longitudinal section through both frames of the spectacle lenses 3 in a horizontal form. Here, the profile of the step-like chamfer is identifiable as extending from the back side of the spectacle frame 1 in this case. It is clear that said chamfer extends as a circle section, with a radius r of approximately 125 mm in the exemplary illustration.

The section B-B is guided vertically through a holder for the spectacle lens 3 in the spectacle frame 1, as a result of which the arrangement of bevel 4 and chamfer 2 likewise becomes clear. This is likewise shown, once again, with magnification in the sectional drawing Z of FIG. 8.

Finally, the section C-C shows the vertical section through the bridge of the spectacle frame in FIG. 7.

As a result of the perspective view into the spectacle frame, FIG. 9 allows identification of the circumferential profile of the step-like chamfer, in this case with an arrangement on the back side. The delicateness of this connection region, which is introduced here only at approximately 0.5 mm, becomes clear.

FIG. 10 shows an exploded perspective view of the spectacle frame according to an embodiment of the invention with different types of lenses arranged for insertion.

FIG. 11 shows a detail view of two different lens types showing identical connecting areas in the form of the bevel 4 according to an embodiment.

FIG. 12 shows a further detailed view of the lenses of FIG. 11.

1. Method for fitting spectacle lenses into full rim spectacle frames, comprising machining the edge of the spectacle lenses to be fitted,
comprising the method steps of:
working a circumferential, step-like chamfer with a curvature determined as a section of a sphere surface with a defined radius r into the holders for the spectacle lenses in the full rim spectacle frame on the front side or back side,
machining the edge of the spectacle lenses to be inserted, in the form of a front-side or back-side circumferential step-like bevel with a curvature determined according to the sphere surface with a defined radius r of the chamfer, which consequently represents an exact negative image of the step-like chamfer worked into the spectacle frame,
fitting the spectacle lenses into the holders in the full rim spectacle frames on the front or back side, with precise engagement of the bevel into the chamfer of the spectacle frame, and
adhesively bonding and/or welding the inserted spectacle lenses to the holders in the full rim spectacle frame.

2. Method for fitting spectacle lenses into full rim spectacle frames according to claim 1,
wherein
the step-like chamfer in the holders for the spectacle lenses in the spectacle frame is already worked-in in standardized form during the production of the spectacle frame.

3. Method for fitting spectacle lenses into full rim spectacle frames according to claim 2,
wherein
the full rim spectacle frames are produced with exact fit together with the step-like chamfer in a 3-D printing method.

4. Method for fitting spectacle lenses into full rim spectacle frames according to claim 1,
wherein
the fabrication of the step-like chamfer in the spectacle frame and the marginal step-like bevel on the spectacle lens is realized by way of computer-assisted manufacturing (CAM) by way of CAD data, which undertake the material machining by means of CNC machines.

5. Method for fitting spectacle lenses into full rim spectacle frames according to claim 1,
wherein
fitting of the spectacle lenses into the spectacle frame is implemented in automated fashion, wherein there is conveying of the spectacle frames into an assembly position and positioning of said spectacle frames therein, and
conveying of the spectacle lenses to the holders of the spectacle frames and positioning of said spectacle frames thereon, and
machine fitting of the spectacle lenses into the holders in the spectacle frames with concluding welding and/or adhesive bonding for the final secure connection between the spectacle lenses and the full rim spectacle frames.

6. Method for fitting spectacle lenses into full rim spectacle frames, comprising a machining of the edges of the spectacle lens elements to be fitted, according to claim 4,
wherein
the temples are only assembled after fitting the spectacle lenses into the full rim spectacle frame during the automated manufacture of the spectacles.

7. Spectacles manufactured according to claim 1, comprising a full rim spectacle frame and marginally machined spectacle lenses that are provided with bevels,
wherein the spectacles further comprise
front-side or back-side circumferential step-like chamfers with a curvature determined as a section of a sphere surface with a defined radius r are arranged in the full rim spectacle frame in the holders for the spectacle lenses,
and the inserted spectacle lenses have a front-side or back-side marginally circumferential step-like bevel with a curvature determined according to the sphere surface with a defined radius r of the chamfer, which is embodied as an exact negative image of the step-like chamfer worked into the spectacle frame.

8. Spectacles according to claim 7,
wherein
the spectacle lenses inserted into the spectacle frame in interlocking fashion are securely connected to the spectacle frame by means of adhesive bonding and/or welding.

9. Spectacles according to claim 7,
wherein
the bevel of the spectacle lens adapted to the chamfer of the spectacle frame is fabricated to exactly correspond to the shape profile of the spectacle lens holders in the spectacle frame and to the sphere surface radius, which was used on the spectacle frame for fabricating the chamfer, independently of the structural features lens thickness and surface curvature of said spectacle lens.

10. Spectacles according to claim 7,
wherein
the chamfer worked into the spectacle frame and, consequently, the bevel of the spectacle lenses, which has a negative embodiment in relation thereto, have a defined sphere surface radius of approximately 50 mm to 150 mm.
